(19) United States
(12) Patent Application Publication
(10) Pub. No.: US 2008/0068532 A1
(43) Pub. Date: Mar. 20, 2008

(54) LIQUID CRYSTAL DISPLAY DEVICE, METHOD OF MAKING DIFFUSION FILM, AND DIFFUSION FILM

(75) Inventors: Seung-mo KIM, Cheonan-si (KR); Tae-seok JANG, Seoul (KR); Jin-sung CHOI, Cheonan-si (KR); Jeong-hwan LEE, Suwon-si (KR); Dong-hoon KIM, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/858,262

(22) Filed: Sep. 20, 2007

(30) Foreign Application Priority Data
Sep. 20, 2006 (KR) 10-2006-0091424

(51) Int. Cl. G02F 1/1335; G02B 5/02; G02F 1/13

(52) U.S. Cl. 349/64; 349/187; 359/599

(57) ABSTRACT

A liquid crystal display (“LCD”) device includes an LCD panel, light sources disposed under the LCD panel, a diffusion film disposed between the light sources and the LCD panel, the diffusion film including a film body including a base resin and diffusion elements distributed in the base resin, and a light shield layer formed on a surface of the film body to correspond to the light sources, and an optical plate disposed between the light sources and the diffusion film.

This application claims priority to Korean Patent Application No. 2006-0091424, filed on Sep. 20, 2006, and all the benefits accruing therefrom under 35 U.S.C. §119, the contents of which in its entirety are herein incorporated by reference.

### BACKGROUND OF THE INVENTION

1. Field of the Invention

The present invention relates to a liquid crystal display (“LCD”) device, a method of making a diffusion film, and a diffusion film, and more particularly to a thin diffusion film performing a diffusion function, an LCD device including the thin diffusion film, and the method of making the thin diffusion film.

2. Description of the Related Art

Flat panel display devices such as a liquid crystal display (“LCD”), a plasma display panel (“PDP”), an organic light emitting diode (“OLED”) and etc. have been developed recently in place of conventional cathode ray tubes (“CRTs”).

The LCD device includes an LCD panel. The LCD panel includes a first substrate having thin film transistors (“TFT”), a second substrate placed to correspond to the first substrate, and a liquid crystal layer disposed between the first substrate and the second substrate. Since the LCD panel does not emit light by itself, it includes a backlight unit disposed at the back side of the TFT substrate to provide light. The transmittance of the light provided by the backlight unit is adjusted according to an alignment of liquid crystal.

The backlight unit may be classified into an edge-type and a direct-type according to the position of the light source included in the backlight unit.

In the direct-type backlight unit, a plurality of light sources is disposed under the LCD panel. The direct-type backlight unit can provide light for improved brightness and is usually employed in the LCD device having a large sized screen.

The light generated by the light source changes its characteristics by passing through various optical films and the light is then supplied to the LCD panel. Among these optical films, a diffusion film which diffuses the supplied light includes a film body and a bead coating layer formed on an upper side of the film body.

However, in this type of diffusion film, the bead coating layer causes the diffusion film to be thick. Also, it is difficult to form a light shield layer on the diffusion film to shield a bright line of the light source because the bead coating layer has a rough surface.

### BRIEF SUMMARY OF THE INVENTION

Accordingly, the present invention provides exemplary embodiments of a liquid crystal display (“LCD”) device including a diffusion film which is thin and performs a diffusion function and eliminates a bright line of a light source.

The present invention also provides exemplary methods of making a diffusion film, which is thin and performs a diffusion function and eliminates a bright line of a light source.

According to exemplary embodiments of the present invention, an LCD device includes an LCD panel, light sources disposed under the LCD panel, a diffusion film disposed between the light sources and the LCD panel, the diffusion film including a film body including a base resin and diffusion elements distributed in the base resin, and a light shield layer formed on a surface of the film body to correspond to the light sources, and an optical plate disposed between the light sources and the diffusion film.

The diffusion elements may include a granular diffusion agent or a plurality of bubbles. A melting point of the diffusion agent may be greater than a melting point of the base resin. The base resin may include polyethylene terephthalate (“PET”), and the diffusion agent may include polymethyl metacrylate (“PMMA”).

The light source may include a plurality of lamps disposed substantially parallel to each other, and each lamp may substantially extend longitudinally. The light shield layer may include a plurality of rows corresponding in number to a number of the lamps, each row reflecting a portion of light from a lamp.

The light shield layer may be disposed on a surface of the film body, and the surface may face the LCD panel. A color of the light shield layer may include a white color.

The light shield layer may include at least one of polygonal patterns and circular patterns. The light shield layer may include a plurality of square patterns.

A surface of the film body may be substantially flat.

According to other exemplary embodiments of the present invention, an LCD device includes an LCD panel, light sources disposed under the LCD panel, a diffusion film disposed between the light sources and the LCD panel, the diffusion film including a film body including a base resin which includes polyethylene terephthalate (“PET”) and diffusion elements distributed in the base resin, and a light shield layer including a white color and disposed on a surface of the film body to correspond to the light sources, and an optical plate disposed between the light sources and the diffusion film.

The diffusion elements may include a granular diffusion agent including polymethyl metacrylate (“PMMA”).

The light shield layer may be disposed on a surface of the film body, the surface may face the LCD panel, and the surface of the film body may be substantially flat. The light shield layer may include a plurality of square patterns.

According to still other exemplary embodiments of the present invention, a method of making a diffusion film includes providing a film mixture including a liquid-state base resin including polyethylene terephthalate (“PET”), and a solid-state diffusion agent, forming a raw film by extruding the film mixture in an extruding direction, providing a film body by stretching the raw film in a first direction substantially parallel to the extruding direction and in a second direction which intersects the extruding direction, and forming a light shield layer on at least one surface of the film body.

The diffusion agent may include PMMA.

The first direction and the second direction may be substantially perpendicular to each other.

According to yet other exemplary embodiments of the present invention, a diffusion film includes a film body including a base resin and diffusion elements distributed within the base resin, the film body having a first surface and a substantially flat second surface, and a light shield layer disposed on the second surface of the film body, the light shield layer comprising a plurality of rows of light shielding material configured to reflect light towards the first surface. Each row of light shielding material may include a pattern of polygonal or circular shapes.

### BRIEF DESCRIPTION OF THE DRAWINGS

The above and/or other aspects, features, and advantages of the present invention will become apparent and more readily appreciated from the following description of the embodiments, taken in conjunction with the accompanying drawings of which:

FIG. 1 is an exploded perspective view of an exemplary liquid crystal display (“LCD”) device according to an exemplary embodiment of the present invention;

FIG. 2 is a sectional view of a main part of the exemplary LCD device according to the exemplary embodiment of the present invention of FIG. 1;

FIG. 3 is an enlarged front perspective view of part “A” in FIG. 1;

FIG. 4 is a sectional view taken along line IV-IV in FIG. 3;

FIG. 5 is a sectional view illustrating paths of a light in the exemplary LCD device according to the exemplary embodiment of the present invention of FIG. 1;

FIG. 6 is a block diagram illustrating an exemplary method of making an exemplary diffusion film according an exemplary embodiment of the present invention;

FIG. 7 is a perspective view illustrating the exemplary method of making the diffusion film according to the present invention;

FIG. 8 is a perspective view of an exemplary diffusion film employed in an exemplary LCD device according to another exemplary embodiment of the present invention; and

FIG. 9 is a perspective view of an exemplary main part of an exemplary LCD device according to still another exemplary embodiment of the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “all, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

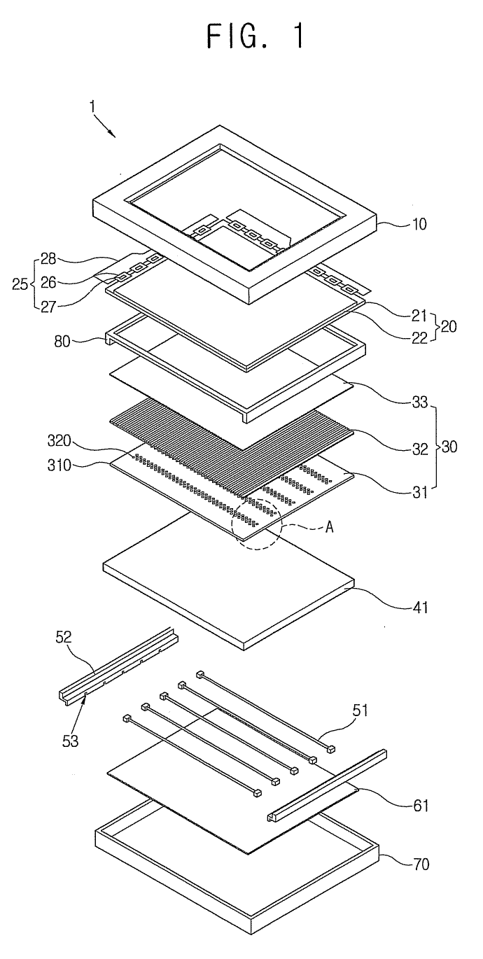

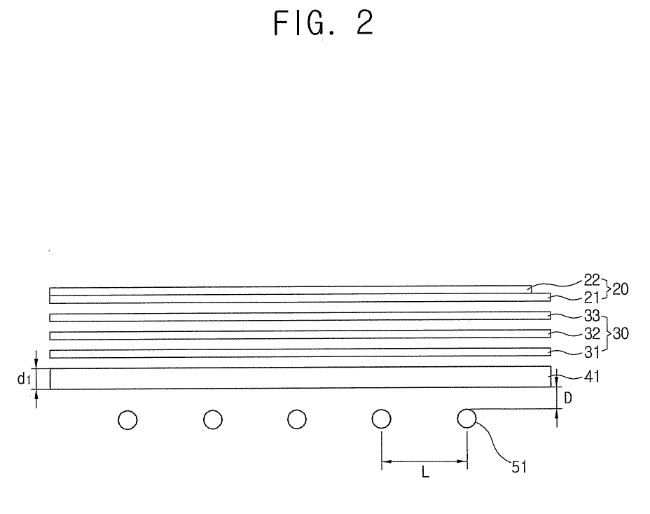

An exemplary embodiment of the present invention will now be described hereinafter with reference to FIG. 1 and FIG. 2.

A liquid crystal display (“LCD”) device 1 includes an LCD panel 20, an optical film 30 disposed at the back side of the LCD panel 20, an optical plate 41 disposed at the back side of the optical film 30, a plurality of light sources 51 disposed at the back side of the optical plate 41, and a reflection plate 61 disposed at the back side of the plurality of light sources 51.

These elements are accommodated between an upper cover 10 and a lower cover 70. The LCD panel 20 is placed on a panel support member 80, and both ends of the light sources 51 are fixed by side molds 52.

The LCD panel 20 includes a first substrate 21 having thin film transistors (“TFTs”) and a second substrate 22 placed to correspond to the first substrate 21. A liquid crystal layer (not shown) is disposed between the first substrate 21 and the second substrate 22. The LCD panel 20 forms pictures by adjusting the arrays of the liquid crystal layer. However, since the LCD panel 20 does not emit light by itself, it should be supplied with light by the plurality of light sources 51 disposed at a back side of the LCD panel 20.

A driver 25 is provided at a first side of the first substrate 21 to apply driving signals. The driver 25 includes a flexible printed circuit (“FPC”) 26, a drive chip 27 mounted on the FPC 26, and a printed circuit board (“PCB”) 28 connected to an opposite side of the FPC 26.

The driver 25 which is shown in FIG. 1 is of a chip-on-film (“COF”) type. However, the driver 25 may be of other conventional types such as a tape carrier package (“TCP”) type, a chip-on-glass (“COG”) type, etc. Alternatively, the driver 25 may be merged directly into the first substrate 21.

Optical films 31, 32, and 33 which are disposed at the back side of the LCD panel 20 include a diffusion film 31, a prism film 32, and a protection film 33.

The diffusion film 31 includes a film body 310 and a light shield layer 320 formed on the upper surface of the film body 310. The light shield layer 320 is formed to correspond to the light sources 51. The diffusion film 31 diffuses light received through the optical plate 41, and prevents bright lines from being generated due to the plurality of light sources 51.

The configuration and the operation of the diffusion film 31 will be described in more detail below.

Triangular column-shaped prisms are formed in a uniform array on the upper surface of the prism film 32, although the prisms may be formed of various shapes and sizes.

The prism film 32 refracts the light diffused by the diffusion film 31 to be in a direction perpendicular to the surface of the LCD panel 20. In exemplary embodiments, two sheets of the prism film 32 are employed in the LCD device 1, and micro prisms are formed on each prism film 32 to include a predetermined angle. Most or substantially all of the light which has passed through the prism film 32 advances perpendicularly toward the LCD panel 20 to provide uniform distribution of brightness.

The protection film 33 is disposed on an upper layer of the optical film 30 to protect the prism film 32 which is fragile or sensitive to scratches.

The optical plate 41 disposed at the back side of the diffusion film 31 may be made of polymethyl metacrylate (“PMMA”) or polycarbonate (“PC”). The optical plate 41 may perform a function of diffusion. The thickness d1 of the optical plate 41 may be about 1 millimeter (mm) to about 5 mm. A distance between the optical plate 41 and the reflection plate 61 may be maintained relatively constant, due to the relatively high strength of the optical plate 41. A supporter (not shown) may be included to maintain the distance between the optical plate 41 and the reflection plate 61.

In an exemplary embodiment of the present invention, the light sources 51 are lamps disposed substantially parallel to each other. The plurality of light sources 51 is disposed in the entire region corresponding to the LCD panel 20, and both ends of each light source 51 are accommodated in side molds 52. The side molds 52 include accommodation hollows 53 to accommodate the light sources 51. The light sources 51 may include cold cathode fluorescent lamps (“CCFL”) or external electrode fluorescent lamps (“EEFL”).

A plurality of the side molds 52 is provided along opposite sides of the LCD panel 20. In exemplary embodiments, the side molds 52 may also perform a role of supporting the optical plate 41.

The reflection plate 61 is disposed under the light source 51 to reflect light directed downward such that the light may be supplied to the optical plate 41. The reflection plate 61 may be made of plastics such as polyethylene terephthalate (“PET”) or polycarbonate (“PC”).

In the LCD device 1, the distance L between the light sources 51, and the distance D between the light sources 51 and the optical plate 41 are closely related to each other.

If the distance D between the light sources 51 and the optical plate 41 is decreased, the thickness of the LCD device 1 may be decreased. In further exemplary embodiments, if the distance L between the light sources 51 is increased, the number of the light sources 51 may be decreased, however the brightness of each light source 51 should be increased. Then, bright lines may be generated on a screen corresponding to the light sources 51 by the increased brightness of each light source 51.

If the distance D between the light sources 51 and the optical plate 41 is increased, the generation of bright lines may be suppressed. However, the ratio of L/D cannot be increased but is generally provided to be equal to or less than about 1.6.

The exemplary diffusion film 31 according to the present invention includes excellent performance in diffusion and can prevent bright lines due to the plurality of light sources 51, such that the ratio L/D may be increased. Also, the thickness of the diffusion film 31 itself can be decreased as compared to a thickness of conventional diffusion films, such that the thickness of the LCD device 1 may further be decreased. In addition, the problem of a bead coating layer on a conventional diffusion film causing scratches on the prism film 32 may be decreased by exemplary embodiments of the diffusion film 31 according to the present invention.

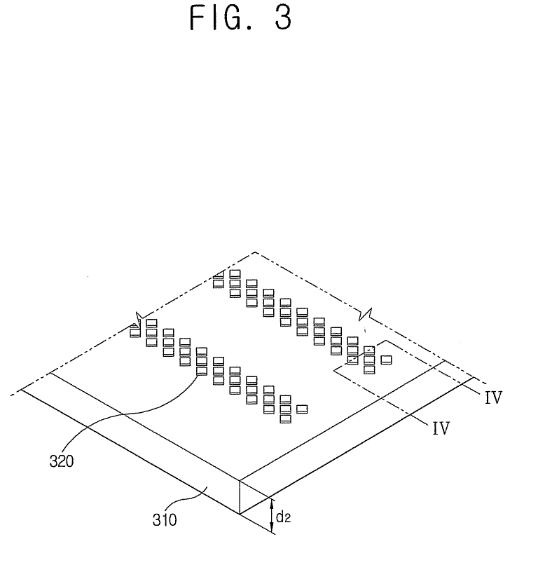

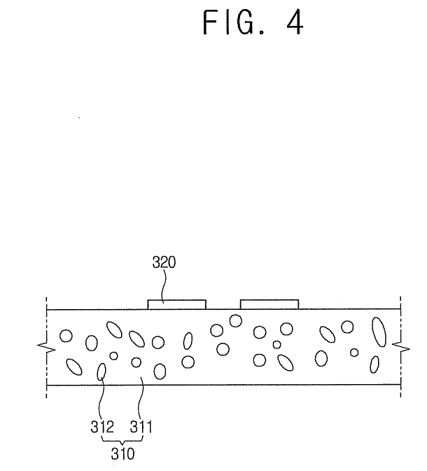

Hereinafter, the exemplary diffusion film 31 according to the present invention will be described in more detail with reference to FIG. 3 to FIG. 5.

As shown in FIG. 3, the diffusion film 31 includes the film body 310 having a shape of film, such as a rectangular shape, and the light shield layer 320 formed on the upper side of the film body 310. The thickness d2 of the film body 310 may be equal to or less than about 200 μm, more specifically, between about 100 μm and about 200 μm.

The film body 310 includes a base resin 311 of a continuous state, and a diffusion agent 312, such as a granular diffusion agent, distributed in the base resin 311. In exemplary embodiments, the base resin 311 may be made of polyethylene terephthalate (“PET”), and the diffusion agent 312 may be made of polymethyl methacrylate (“PMMA”). A refractive index of the base resin 311 is provided to be different from a refractive index of the diffusion agent 312. The diffusion agent 312 is provided to have a melting point higher than a melting point of the base resin 311. In alternative exemplary embodiments, the base resin 311 may be made of polycarbonate. Surfaces of both sides of the film body 310 are substantially flat.

The light shield layer 320 includes a white color, and extends to correspond to the plurality of light sources 51, that is, the light shield layer 320 is disposed along the light sources 51. For example, the light shield layer 320 may be formed in rows on the film body 310, and the number of rows may correspond to the number of light sources 51, and each row may overlap a location corresponding to a light source 51. As shown in FIG. 3, the light shield layer 320 includes a plurality of square patterns disposed adjacent to each other. The plurality of square patterns is disposed in a repeating pattern and extends in a direction corresponding to the plurality of light sources 51. That is, each row within the light shield layer 320 includes a plurality of square patterns.

In other exemplary embodiment, the density of the light shield layer 30 may decrease as the light shield layer 30 is distanced from the light source 51.

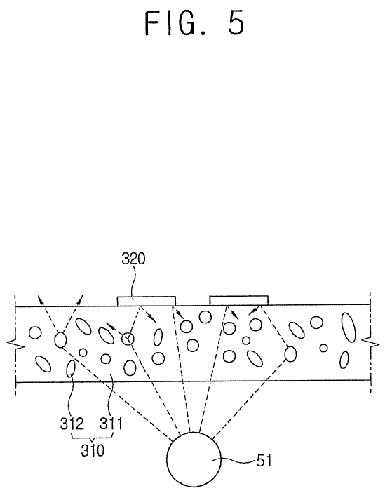

FIG. 5 is a block diagram illustrating exemplary paths of the light, which enters the diffusion film 31 from the light sources 51. The optical plate 41 is not shown in FIG. S.

Most or substantially all of the light entering the diffusion film 31 meets the diffusion agent 312. The refractive index of the diffusion agent 312 is different from the refractive index of the base resin 311, such that the path of the light is bent while the light passes through the diffusion agent 312, and thus diffusion occurs.

The light from the plurality of light sources 51 enters the diffusion film 31 most intensively at portions of the diffusion film 31 closest to the plurality of light sources 51, such as portions of the diffusion film 31 directly above the light sources 51. Accordingly, bright lines may occur along the light sources 51. In this exemplary embodiment, these bright lines may be decreased by the light shield layer 320 disposed along the plurality of light sources 51.

The light encountering the light shield layer 320 is reflected and enters the film body 310 again. Some of the light entering the film body 310 meets the diffusion agent 312, and the remaining light heads toward the reflection plate 61 to be recycled. Since the light shield layer 320 is white, the reflection and the recycling of the light may be easily achieved. Accordingly, the occurrence of the bright lines due to the light sources 51 may be decreased.

As described above, the diffusion film 31 according to an exemplary embodiment of the present invention is excellent in performing diffusion and preventing the occurrence of the bright lines. Therefore, the ratio L/D may be increased, which means the thickness of the LCD device 1 can be decreased and the number of the light sources 51 can be decreased.

As the diffusion film 31 according to the exemplary embodiment of the present invention includes the diffusion agent 312 disposed in the film body 310, there is no need to prepare a bead coating layer and thus the thickness of the diffusion film 31 can be decreased. Also, since the surface of the film body 310 is substantially flat with the absence of the bead coating layer, it is easy to form the light shield layer 320 on the surface of the film body 310.

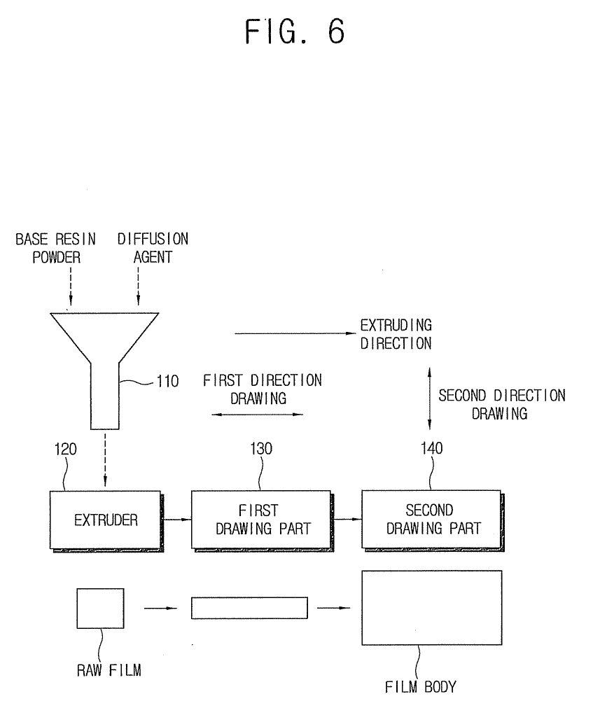

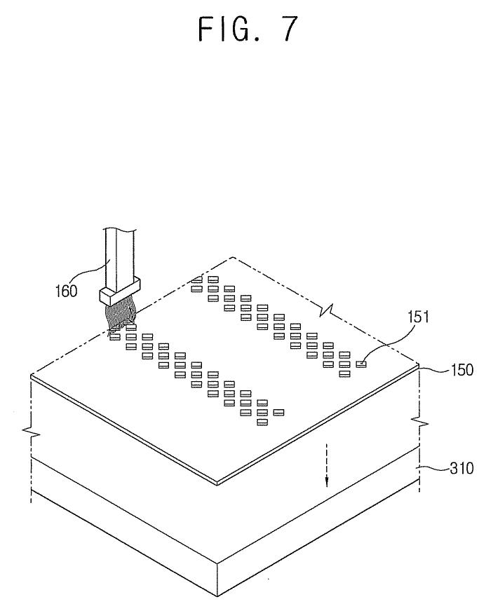

In other exemplary embodiment, a diffusing plate may be employed instead of the diffusion film 31. The diffusing plate may comprise plate body including a foamed diffusing member and a light shield layer formed on a surface of the plate body to correspond to the light sources 51. In this case, the optical plate 41 can be omitted. Hereinafter, an exemplary method of making the diffusion film 31 according to the present invention will be described in more detail with reference to FIG. 6 and FIG. 7.

Firstly, a base resin powder constituting the base resin 311 and the diffusion agent 312 is injected in a melting part 110. The base resin powder may be PET, and the diffusion agent 312 may be PMMA bead.

Only the base resin powder is melted in the melting part 110, thus a film mixture including liquid-state base resin and solid-state diffusion agent 312 is provided. For this purpose, the melting point of the diffusion agent 312 should be higher than a melting point of the base resin powder.

Secondly, the film mixture is supplied to an extruder 120 to obtain a raw film. The raw film is thicker than the film body 310 to be manufactured, and the PET molecules in the raw film are in an amorphous state.

The raw film passes through a first drawing part 130 and a second drawing part 140 to make the film body 310. The first drawing part 130 draws the raw film in a first direction substantially parallel to an extruding direction, and the second drawing part 140 draws the raw film in a second direction substantially perpendicular to the first direction. The film body 310 formed by drawing is thinner and larger than the raw film. Also, the film body 310 is strengthened because the PET molecules are crystallized by the drawing.

During the drawing process, the diffusion agent 312 which has been non-uniformly distributed in the raw film becomes uniformly distributed, thus the diffusion film 31 will have a certain haze value.

In an alternative exemplary method, bubbles may be inserted into the base resin of liquid state as diffusion elements instead of the granular diffusion agent 312. In this exemplary embodiment, a plurality of bubbles is contained in the film body 310 and the incident light is diffused by the bubbles.

Then, as shown in FIG. 7, the light shield layer 320 is formed on the film body 310 using a mask 150 and an ink printing part 160. The ink printing part 160 contains ink. The ink includes a white material which constitutes the light shield layer 320, and a solvent in which the white material is dissolved.

The mask 150 has openings 151 corresponding to the light shield layer 320 to be formed. The mask 150 is disposed on the film body 310, and the ink is printed onto an exposed portion of the film body 310 through the openings 151 using the ink printing part 160. Then, the solvent in the ink is removed by drying to form the light shield layer 320. Since the surface of the film body 310 is substantially flat, the light shield layer 320 can be easily formed.

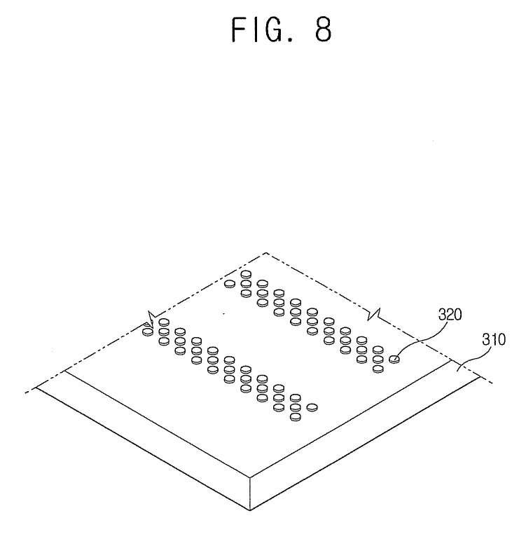

An LCD device according to another exemplary embodiment of the present invention will be described with reference to FIG. 8.

In this exemplary embodiment, a light shield layer 320 is provided as a plurality of circular patterns. Alternatively, the light shield layer 320 may be provided as a plurality of polygonal patterns, such as triangular patterns and pentagonal patterns, or provided as stripes extending along the extending direction of the plurality of light sources 51.

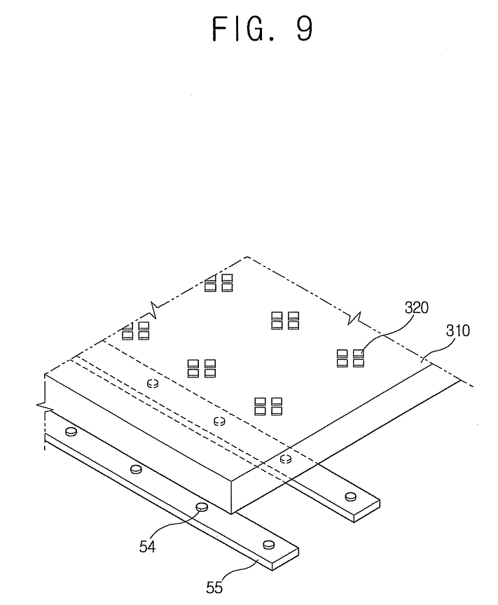

An LCD device according to another exemplary embodiment of the present invention will be described with reference to FIG. 9.

In this embodiment, light sources 54 are dot-shaped light-emitting diodes (“LEDs”) evenly distributed and mounted on an LED substrate 55.

Dot shapes of light shield layers 320 are distributed on a film body 310 of a diffusion film 31 to correspond to the light sources 54.

As described above, according to exemplary embodiments of the present invention, an LCD device including a diffusion film which is thin and performs a diffusion function which can eliminate a bright line of a light source is provided.

Also, as described above, according to the present invention, an exemplary method of making a diffusion film which is thin and performs a diffusion function which can eliminate the bright line of a light source is provided.

Although a few exemplary embodiments of the present invention have been shown and described, it will be appreciated by those skilled in the art that various changes may be made in these embodiments without departing from the principles and spirit of the invention, the scope of which is defined in the appended claims and their equivalents.

What is claimed is:

1. A liquid crystal display device comprising:
a liquid crystal display panel;
light sources disposed under the liquid crystal display panel; and
a diffusion film disposed between the light sources and the liquid crystal display panel, the diffusion film comprising a film body including a base resin and diffusion elements distributed in the base resin, and a light shield layer formed on a surface of the film body to correspond to the light sources.

2. The liquid crystal display device according to claim 1, wherein the diffusion elements include a granular diffusion agent or a plurality of bubbles.

3. The liquid crystal display device according to claim 2, wherein the diffusion elements include the granular diffusion agent and a melting point of the diffusion agent is higher than a melting point of the base resin.

4. The liquid crystal display device according to claim 3, wherein the diffusion agent comprises polymethyl metacrylate.

5. The liquid crystal display device according to claim 1, wherein the light sources comprise a plurality of lamps disposed substantially parallel to each other, each lamp substantially extending longitudinally.

6. The liquid crystal display device according to claim 5, wherein the light shield layer includes a plurality of rows corresponding in number to a number of the lamps, each row reflecting a portion of light from the lamps.

7. The liquid crystal display device according to claim 1, wherein the light sources comprise light emitting diodes.

8. The liquid crystal display device according to claim 1, wherein the density of the light shield layer decreases as the light shield layer becomes distant from the light sources.

9. The liquid crystal display device according to claim 1, wherein the light shield layer is disposed on a surface of the film body, the surface facing the liquid crystal display panel.

10. The liquid crystal display device according to claim 1, wherein a color of the light shield layer is white.

11. The liquid crystal display device according to claim 1, wherein the light shield layer comprises at least one of polygonal patterns and circular patterns.

12. The liquid crystal display device according to claim 11, wherein the light shield layer comprises a plurality of square patterns.

13. The liquid crystal display device according to claim 1, wherein the surface of the film body is substantially flat.

14. The liquid crystal display device according to claim 1, wherein the base resin comprises polyethylene terephthalate.

15. A method of making a diffusion film, the method comprising:
providing a film mixture comprising a liquid-state base resin, and a solid-state diffusion agent;
forming a raw film by extruding the film mixture in an extruding direction;
providing a film body by stretching the raw film in a first direction substantially parallel to the extruding direction and in a second direction which intersects the extruding direction; and
forming a light shield layer on at least one surface of the film body.

16. The method according to claim 15, wherein the diffusion agent comprises polymethyl metacrylate.

17. The method according to claim 15, wherein the base resin comprises polyethylene terephthalate.

18. The method according to claim 15, wherein the first direction and the second direction are substantially perpendicular to each other.

19. The method according to claim 15, wherein the film mixture is provided by melting only the base resin, a melting point of the base resin being lower than a melting point of the diffusion agent.

20. A diffusion film comprising:
a film body including a base resin and diffusion elements distributed within the base resin, the film body having a first surface and a substantially flat second surface; and
a light shield layer disposed on the second surface of the film body, the light shield layer comprising a plurality of rows of light shielding material configured to reflect light towards the first surface.

21. The diffusion film according to claim 20, wherein each row of light shielding material includes a pattern of polygonal or circular shapes.

22. A liquid crystal display device comprising:
a liquid crystal display panel;
light sources disposed under the liquid crystal display panel; and
a diffusion plate disposed between the light sources and the liquid crystal display panel, the diffusion plate comprising a plate body including a foamed diffusing member, and a light shield layer formed on a surface of the plate body to correspond to the light sources.
